(19) United States
(12) Patent Application Publication
(10) Pub. No.: US 2009/0179505 A1
(43) Pub. Date: Jul. 16, 2009

(54) POLYGONAL ELECTRICAL MACHINE

(75) Inventors: Thomas Hoppe, Altdorf (DE); Zeljko Jajtic, München (DE); Christian Volmert, München (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/576,208

(22) PCT Filed: Sep. 19, 2005
(86) PCT No.: PCT/EP2005/054666

§ 371 Date: Mar. 28, 2007

(30) Foreign Application Priority Data
Sep. 30, 2004 (DE) 10 2004 047 618.7
Jun. 3, 2005 (DE) 10 2005 025 672.4

(51) Int. Cl. H02K 41/03

(52) U.S. Cl. 310/12.17

(57) ABSTRACT

The invention relates to a polygonal electric linear motor. In said motor, a primary part that is provided with transversal flux windings (16) comprises (4) a secondary part (8) with permanent magnets (44). The air gap faces (50, 51) or windings (16) have a polygonal shape.

The invention relates to an electrical machine having a polygonal cross section. The electrical machine is provided for performing a linear movement. A linear motor is consequently an example of such an electrical machine. Since a linear motor can also be used as a generator, the electrical machine therefore also relates to a linear generator. The electrical machine has a primary part and a secondary part. An electrical machine will be understood below to mean an electrical machine whose primary part can move linearly with respect to the secondary part, or vice versa. Furthermore, the invention also relates to a primary part having a polygonal cross section of an electrical machine.

In machine and installation design, linear motors have gained considerable significance as direct electrical drives. Their advantages, such as the dynamic response of the control system which can be achieved, the high degree of positioning accuracy, the accelerations and speeds which are possible and the long displacement paths, make them superior to other drives.

The primary part of the electrical machine has windings, it being possible for a variable magnetic field to be produced by means of windings through which current is flowing, this magnetic field, by means of interacting with an excitation field, making possible a movement of the primary part with respect to the secondary part, or vice versa. The excitation field is produced, for example, by permanent magnets, which are fitted to the secondary part and/or the primary part.

Sometimes an increased thrust force is required for some applications of linear motors. A method of increasing the thrust force consists in extending the single-comb linear motor, by using a second primary part, to form a double-comb linear motor, which achieves twice the thrust force. One advantage of the use of two primary parts consists in the fact that the thrust force is doubled without increasing the physical length.

The German patent application with the official file reference 103 29 651.4 has disclosed, for example, a linear motor which has a polygonal cross section. This physical shape makes a high thrust force possible given a compact design. The primary part of the linear motor has a plurality of laminate stacks arranged in the form of a polygon and circumferential winding coils. The normal forces acting on the laminate stack with this construction need to be absorbed by a mount structure surrounding the laminate stack. The design of the mount structure is complex and increases the installation area required for the electrical machine. The laminate stacks can be assembled in modular fashion to form primary parts comprising different numbers of laminate stacks, with the result that various motors having different powers can be produced in a simple manner. These linear motors are characterized by a high thrust force with a short physical shape.

The invention is based on the object of specifying an electrical machine which can have a compact design and minimizes the abovementioned disadvantages.

This object is achieved according to the invention by means of an electrical machine having the features as claimed in claim 1 and 8, respectively. Dependent claims 2 to 7 and 9 to 11 specify advantageous configurations of the invention. The object is further achieved by means of the apparatuses as claimed in claims 12, 16, 20 and 21. Dependent claims 13 to 15, 17 to 19 and 22 and 23 specify further advantageous configurations of the invention.

With the aid of the invention it is possible to provide an electrical machine which is, in particular, a linear motor having a high power with a small physical length, it being possible to realize a range of motors with a broad power range in a simple and cost-effective manner. Owing to the stacking height of the laminate stack, various motor lengths and therefore various powers, for example, can be achieved with one laminate section geometry.

In an electrical machine according to the invention which is, in particular, a linear motor, which has a primary part and a secondary part, the primary part having windings for producing a magnetic field, and the secondary part having a means for guiding a magnetic flux, and an air-gap face being formed between the primary part and the secondary part, the windings of the primary part and/or the air-gap faces are arranged in the form of a polygon.

The electrical machine advantageously has at least two magnetically active air-gap faces, one or more windings being capable of being or being associated with each magnetically active air-gap face. A magnetically active air-gap face is provided for guiding a useful flux and is also provided for forming a thrust force. The assignment of the one or more windings relates to the guidance of the magnetic flux which is coupled to the winding of the primary part. The air-gap faces under consideration are therefore in particular magnetically active and are also used for forming a force. The air-gap face is advantageously a plane, i.e. a face, which does not have a curvature. Since the primary part and the secondary part are separated from one another via an air gap, and the air gap advantageously has an at least substantially equal width, at least with respect to one side of the polygon and in a longitudinal direction (corresponds to the movement direction), this results in air-gap faces. In this case, the air-gap face relates both to the side of the primary part in the air gap and to the side of the secondary part in the air gap. The various air-gap faces are arranged in the form of a polygon. One example of a means for guiding the magnetic field is a laminate stack.

The electrical machine also has a further means for producing a magnetic field, these further means being used for producing an excitation field. The further means is arranged either on the primary part or on the secondary part. The excitation field and therefore an excitation flux of the electrical machine is produced, for example, by means of permanent magnets. The permanent magnets are fitted, for example, to the secondary part of the electrical machine. In a further configuration of the electrical machine, the permanent magnets are fitted to the primary part of the electrical machine. Both the primary part and the secondary part can therefore have permanent magnets or the further means for producing an excitation field.

The polygonal arrangement of the windings and/or the air-gap faces of the primary part is advantageously realized by a laminate section suitable for this purpose of a laminate stack of the primary part. The polygonal shape has the advantage that magnetic attraction forces in the air gap can be absorbed by the laminate stack. If an integral design is provided for a laminate in the laminate section, this has further advantages with respect to high mechanical rigidity of a closed structure of the shape of the laminate section.

In addition to laminate stacks, which have laminates which are integral in cross section as the laminates, cross sections can also be implemented which have a plurality of laminates in cross section. A resulting advantage is, for example, the fact that the primary part can be wound more easily.

In a further configuration, the polygon is open, this resulting in an open laminate stack of the primary part, with the result that the open side of the polygon or of the laminate stack can be used, for example, for guiding the secondary part or as a support area for the secondary part. In these described configurations of the polygonal arrangement of the windings of the primary part and/or the air-gap faces of the primary part, an advantage advantageously results to the extent that attraction forces are at least partially compensated for.

The electrical machine according to the invention can be implemented such that either

a) the primary part is arranged in an outer region of the electrical machine and the secondary part is arranged in an inner region of the electrical machine or
b) the primary part is arranged in an inner region of the electrical machine and the secondary part is arranged in an outer region of the electrical machine.

In embodiment a), the primary part at least partially surrounds the secondary part. In embodiment b), the secondary part at least partially surrounds the primary part. Since the electrical machine is provided for performing a linear movement, the surrounding of the primary part or of the secondary part in each case only relates to a subregion of a longitudinal extent of the electrical machine. In both embodiments a) and b) it is possible either for the primary part to be provided for performing a linear movement or for the secondary part to be provided for performing a linear movement.

In a further configuration, the excitation field can also be produced by means of coils or windings through which current is flowing.

In the polygonal arrangement of the windings, these windings are advantageously positioned in particular such that a useful magnetic flux is guided entirely or at least predominantly in a plane aligned transversely with respect to a movement direction of part of the electrical machine. This results in a quadrature-axis flux arrangement. The movement direction of part of the electrical machine is either the movement direction of the primary part with respect to the secondary part or the movement direction of the secondary part with respect to the primary part, i.e. it is at least one relative movement.

In contrast to an electrical machine which has a polygonal direct-axis flux arrangement, in a polygonal quadrature-axis flux arrangement forces which act on the laminate stack of the primary part and are brought about by the windings, through which current flows, of the primary part and/or the excitation field of the permanent magnets can be eliminated within the laminate section. The direct-axis flux arrangement is characterized by the fact that the magnetic fields are not closed transversely with respect to the movement direction of the primary part or the secondary part but along the movement direction of the primary part or along the movement direction of the secondary part. The magnetic flux which is guided in a plane which is oriented parallel to the movement direction, is the useful magnetic flux in the direct-axis flux arrangement. The useful magnetic flux is the magnetic flux which is coupled to the windings of the primary part. This useful magnetic flux which is aligned in such a way forms a direct-axis flux magnetic circuit. The stacking direction of the laminates of the laminate stack of the primary part of an electrical machine with a direct-axis flux arrangement is parallel to the movement direction. The normal forces occurring cannot be absorbed by the motor laminates alone. The laminate stacks arranged in the form of a polygon therefore need to be held by a surrounding mount structure.

In the electrical machine according to the invention, a quadrature-axis flux arrangement is selected. The quadrature-axis flux arrangement is characterized by the fact that the magnetic fields are not closed along the movement direction of the primary part or of the secondary part but transversely with respect to the movement direction of the primary part or transversely with respect to the movement direction of the secondary part. The magnetic flux, which is guided in a plane which is oriented transversely with respect to the movement direction, is the useful magnetic flux in the quadrature-axis flux arrangement. The useful magnetic flux is the magnetic flux which is coupled to the windings of the primary part. This useful magnetic flux aligned in such a way forms a quadrature-axis flux magnetic circuit.

In addition to a conventional design of a linear motor, as is disclosed, by way of example, in DE 100 03 851, there is the polygonal design according to the invention. This design makes it possible to realize a linear motor in which a guide of the primary part in relation to the secondary part and/or vice versa is also integrated in these parts. According to the invention, the guide is therefore integrated in the primary part and/or in the secondary part.

Direct drives such as linear motors or torque motors require, for example, a linear guide or a bearing designed for rotary movements for guidance purposes. When the direct drive is fitted on a machine, it is then often necessary to combine a plurality of components, such as the linear motor itself with its primary part and its secondary part, a guide and, for example, also a measurement system with one another. Direct drives are therefore usually integrated motors. In the case of a linear motor, the components primary part and secondary part are held at a distance by means of two guides, for example, the primary part and the secondary part being located between the two guides.

This design is very complex and also requires a large amount of installation space. An improved design of an electrical machine will be described below which is, in particular, a linear motor.

An electrical machine which has a primary part, a secondary part and a guide can be designed such that the guide is integrated at least partially in the primary part and/or in the secondary part. As a result, a very compact construction can be realized. This relates in particular to linear motors.

Advantageously, a profiled rail in the form of a guide rail is used as the guide, and this profiled rail is at the same time used to form the secondary part of the electrical machine as well.

An improved design can also be achieved in an electrical machine which has a primary part and a secondary part, with:

a) the primary part only partially surrounding at least part of the secondary part, or
b) the secondary part only partially surrounding at least part of the primary part,
in particular a guide, such as a guide rail, for example, being integrated at least partially in the primary part and/or in the secondary part. The partially surrounding arrangement makes it possible to realize a more compact design. However, the design can also be utilized advantageously to the extent that it is possible to realize a guide function owing to this partially surrounding arrangement. The guide relates to a relative movement of the primary part in relation to the secondary part of the electrical machine.

In one advantageous configuration of the electrical machine, the secondary part contributes at least to providing a support area for the primary part. The primary part can thus be fitted, for example, to a machine (for example a machine tool or a production machine) without it being necessary for guides to be mounted on the machine in advance for the linear motor.

Owing to the combination or integration of individual components, such as a guide and a secondary part, for example, a complete electrical machine can be provided which has in particular both the primary part, the secondary part and the guide of the two parts (primary part with respect to the secondary part, and vice versa). A measurement system for measuring the movement is advantageously also integrated in this electrical machine. A complete motor can thus be produced. The measurement system is in this case integrated in the guide as well in a further advantageous configuration.

The described design of the linear motor has the advantage that the guide is also integrated in the primary part or in the secondary part. Advantageously, this integration also makes it possible to dispense with a magnetic track for the measurement system since permanent magnets, for example, can be used on the secondary part as the magnetic track.

A primary part of an electrical machine which has the primary part and a secondary part, the primary part having windings for producing a magnetic field, and the secondary part having a means for guiding a magnetic flux, can be designed in one embodiment according to the invention such that a slot-like receptacle is formed by means of the primary part, the slot-like receptacle being provided for accommodating at least part of the secondary part. The configuration of the primary part and the configuration of the secondary part are therefore matched to one another such that one part has a positive shape and the other part has a negative shape corresponding thereto, and these shapes are arranged so as to point towards one another in the electrical machine.

Advantageously, the slot-like receptacle acts as a guide means for guiding the primary part in relation to the secondary part. In this case, the guide can be designed such that the primary part is integrated in a recirculating roller unit and/or in a recirculating ball unit of a linear guide.

If the guide is not based on a bearing with moveable parts such as rollers or balls, the guide can also be realized by means of a sliding bearing. In this variant, the primary part has a contact region with the secondary part, the contact region being located in particular in the region of the slot-like receptacle, and, for example, the primary part having a slide-promoting surface in the contact region. Alternatively to this, the secondary part may also have the slide-promoting surface. In a further configuration, both the primary part and the secondary part have slide-promoting surfaces.

However, in a further configuration, instead of the primary part also the secondary part of an electrical machine can also be shaped similarly to the primary part. In this case, the secondary part has a slot-like receptacle, the slot-like receptacle being provided for accommodating at least part of the primary part.

In a similar way to the primary part, in the secondary part, too, the slot-like receptacle is advantageously used as a guide means for guiding the primary part in relation to the secondary part.

In further configurations, a recirculating roller unit and/or a recirculating ball unit of a linear guide is integrated in the secondary part. This is useful for a compact design.

If the recirculating roller unit or else the recirculating ball unit is not integrated in the primary part or the secondary part, the primary part or else the secondary part can also be positioned, for example, between two recirculating roller units or between two recirculating ball units. Although this increases the installation space required, it does have the advantage of a simpler design.

A simple design results, as already described for the primary part, from the use of a sliding bearing. The sliding bearing has at least one slide-promoting surface. This slide-promoting surface is located, for example, on the primary part and/or on the secondary part and relates to the contact region.

If, therefore, the secondary part has a contact region with the primary part, the contact region being located in the region of the slot-like receptacle, the slide-promoting surface for example of the secondary part is located in the contact region between the primary part and the secondary part.

The slide-promoting surface, which is formed, for example, by a sliding layer or else by a sliding film, advantageously also fulfills a further function in addition to the functionality as a bearing. This further function is the function of an air gap.

Electrical machines have a primary part and a secondary part. In accordance with the prior art, the primary part and the secondary part are positioned in relation to one another such that an air gap is formed between the primary part and the secondary part. A guide for the primary part and/or the secondary part is required for forming an air gap. With the aid of such a guide, which is used as a spacer, the primary part is spaced apart from the secondary part. In the case of rotary electrical machines, for example, this is possible owing to a mounting arrangement of the rotor, which represents the secondary part. In this case both in rotary electrical machines and in linear motors, which naturally also represent electrical machines, stringent requirements with respect to manufacturing tolerances are placed on the guide, since the air gap needs to be kept constant over the entire range of movement of the secondary part in relation to the primary part. This is necessary in order that the electrical machine always has the same properties, in particular with respect to the development of an electromagnetic force EMF, irrespective of the position of the secondary part in relation to the primary part. Ensuring an air gap with a constant size is complex. This applies in particular to linear motors which may also have long displacement paths.

Since the air gap is very small, it is, for example, also necessary that measures are taken to ensure that no disruptive foreign bodies come between the primary part and the secondary part, i.e. enter the air gap. A foreign body is particularly disruptive when it is has a size which approximately corresponds to the size of the air gap or exceeds this size. Owing to design measures such as owing to covers or else owing to sweeping devices, for example, a situation can be achieved in which no foreign bodies enter the air gap. The problem of foreign bodies in the air gap occurs in particular in the case of linear motors, since, in the case of these linear motors, the air gap is in an exposed position in comparison with a rotary electrical machine which has a stator and a rotor.

If it is now desired either to ensure, in a simple manner, a constant distance between the primary part and the secondary part and/or else to reduce the level of contamination of the space between the primary part and the secondary part, i.e. the air gap, this is achieved in an electrical machine which has a primary part and a secondary part, the primary part having a side facing the secondary part, and the secondary part having a side facing the primary part, these sides being provided for the emergence and/or entry of magnetic fields, by virtue of the fact that the primary part bears at least partially against the secondary part in a contact region. The contact region relates to at least one of the mutually facing sides of the primary part and of the secondary part of the electrical machine, at least one of these sides being provided for the emergence and/or entry of magnetic fields.

Those sides of the primary part or of the secondary part which are provided for the emergence and/or entry of magnetic fields are magnetically active sides. An electrical machine can be embodied such that the primary part at least partially touches the magnetically active side of the secondary part, the secondary part having, for example, permanent magnets, which are always magnetically active.

The electrical machine can be designed such that the primary part has windings and the secondary part has permanent magnets. Magnetic fields can be produced or are produced both owing to the windings and owing to the permanent magnets. These magnetic fields emerge from and/or enter the primary part and/or the secondary part and are closed in each case via the opposite part. With respect to the primary part, touching contact is made with the secondary part, for example at least partially in a region which has windings through which current can flow.

Owing to the touching contact between the primary part and the secondary part in a contact region, which is provided for the entry or emergence of magnetic fields so as to obtain an electromagnetic force EMF, a simple possibility results for implementing a constant spacing between the primary part and the secondary part. Either that side of the primary part which faces the secondary part has a slide-promoting surface and/or that side of the secondary part which faces the primary part has a slide-promoting surface. A sliding layer or a sliding film, for example, is used to form the slide-promoting surface, the air gap being entirely or partially replaced by a sliding layer or the sliding film. The air gap is the region between the secondary part and the primary part of the electrical machine, which contributes to the formation of an electromagnetic force EMF. Magnetic fields, which emerge from the secondary part or the primary part and enter the other, opposite part or emerge therefrom, run in the air gap. In the function of an air gap, the sliding layer advantageously has a similar value μ_{R} to the air gap filled with air. In one configuration of the sliding layer, the sliding layer is in the form of a foil (sliding foil). This has the advantage that, in the event of damage, foils can be replaced easily by a new foil. In a further configuration, the sliding layer is a coating on one side. A possible coating material is, for example, Teflon. The sliding layer should have such a material which has a good sliding property and in particular is also pressure-resistant and subject to little wear.

In one further advantageous configuration, the sliding layer, such as a sliding foil, for example, is replaceable, with the result that the sliding layer can easily be replaced by a new sliding layer in the event of contamination or in the event of a defect.

If the primary part has windings, which are provided for forming forces in preferred directions, advantageously by means of targeted utilization of a magnetic attraction force, which is on one side and can be adjusted in a defined manner, of the primary part to the secondary part, the sliding performance of the primary part in relation to the secondary part can be adjusted in a suitable manner. The adjustment takes place, for example, by selecting different thicknesses for the sliding layer. If a sliding layer is thinner on a first face between the primary part and the secondary part than a sliding layer between a further face between the primary part and the secondary part, the magnetic attraction force in the region of the first face is greater than in the region of the further face. This thus results in a predetermined positioning of the primary part in relation to the secondary part, since different attraction forces result.

In a further embodiment of the linear motor, the slot-like receptacle has a polygonal cross section. In this case, either the primary part of the linear motor or the secondary part of the linear motor has the slot-like receptacle. For the case in which the primary part has the slot-like receptacle, the shape of the secondary part is such that it fits into the slot-like receptacle such that an air gap is formed between the primary part and the secondary part. For the case in which the secondary part has the slot-like receptacle, the shape of the primary part is such that it fits into the slot-like receptacle such that an air gap is formed between the primary part and the secondary part. The air gap either actually has air and/or it has a material which approximately corresponds to the electromagnetic properties of air in order that the functionality of the air gap is maintained.

The slot-like receptacle has an opening, in the case of a linear motor this opening extending linearly with respect to the possible movement direction of the linear motor. This opening can also be referred to as a slot opening. A further configuration of the electrical machine, in particular of the linear motor, results from the fact that the opening has a width which is smaller than half the outer length of the cross section of the slot-like receptacle. The width of the slot opening in this case relates to the width of the opening of the cross section of the slot-like receptacle, i.e. the width of the opening transversely with respect to the longitudinal extent of the slot-like receptacle. The outer length of the cross section relates to the cross section of the slot-like receptacle transversely with respect to its longitudinal extent. In this case, the length is determined by the outer contour of this cross section.

The electrical machine according to the invention can be designed such that either the secondary part and/or the primary part is intended to be fitted such that its position cannot be changed.

The electrical machine, which has a slot-like receptacle integrated in the primary part and/or in the secondary part, can be configured in various ways with respect to its electromagnetic design. As has already been described above in this document, the secondary part, for example, is designed such that it has permanent magnets. In a further variant, the secondary part has bars instead of the permanent magnets, which bars are laminated, for example.

The invention will be described in more detail below by way of example with reference to the drawings, in which:

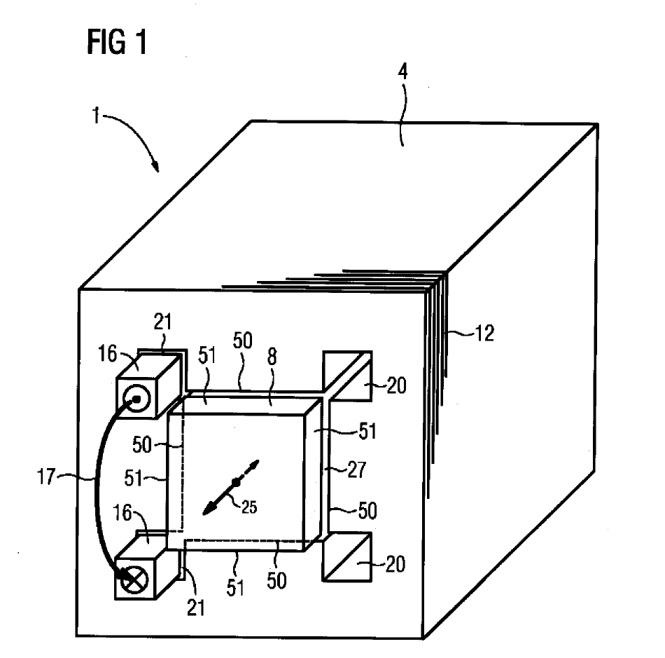

FIG. 1 shows an electrical machine, which is provided for performing a linear movement, the electrical machine having a polygonal arrangement of four air-gap faces or two windings,

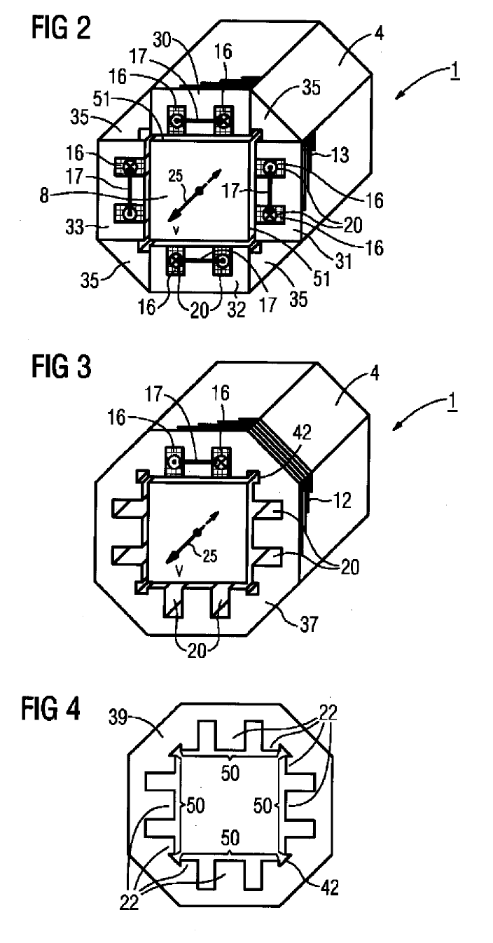

FIG. 2 shows an electrical machine for a polygonal arrangement with four windings, a laminate stack of a primary part of the electrical machine having laminate elements in the laminate section,

FIG. 3 shows an electrical machine for a polygonal arrangement with four windings, the laminate stack of the primary part of the electrical machine having an integral design in the laminate section,

FIG. 4 shows a laminate section for the primary part of the electrical machine,

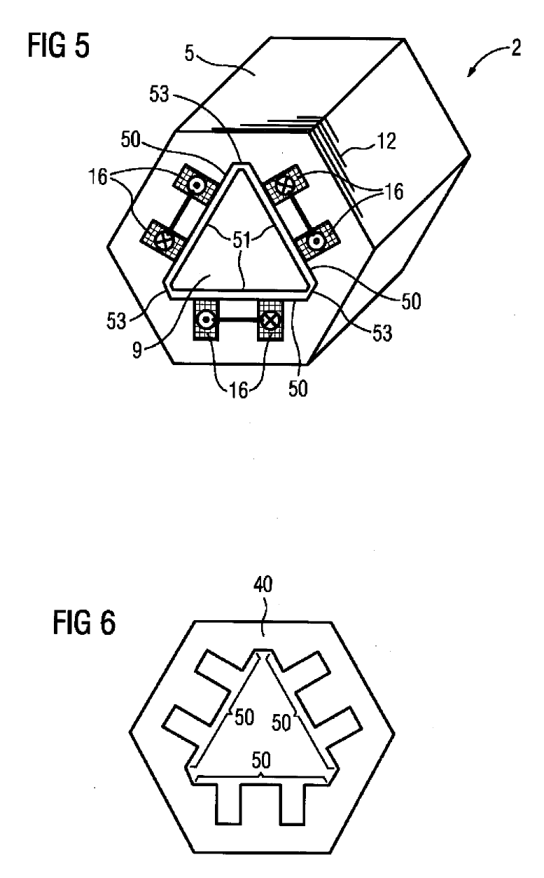

FIG. 5 shows an electrical machine for a polygonal arrangement of three air-gap faces or three windings,

FIG. 6 shows an electrical machine for a polygonal arrangement of three windings, the laminate stack of the primary part of the electrical machine having an integral design in the laminate section,

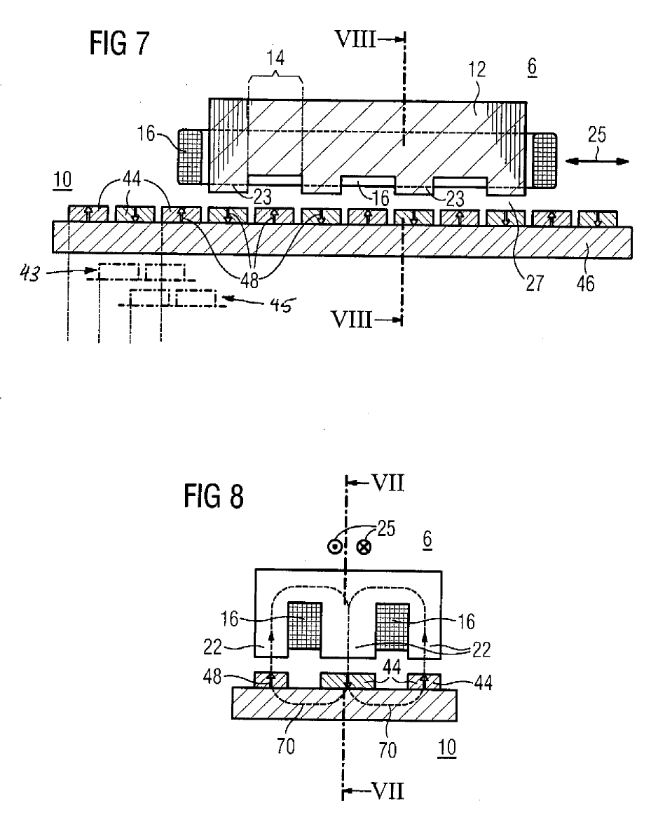

FIG. 7 shows a secondary part with permanent magnets and an associated primary part with a toothed laminate stack,

FIG. 8 shows a section through the primary part and the secondary part shown in FIG. 7,

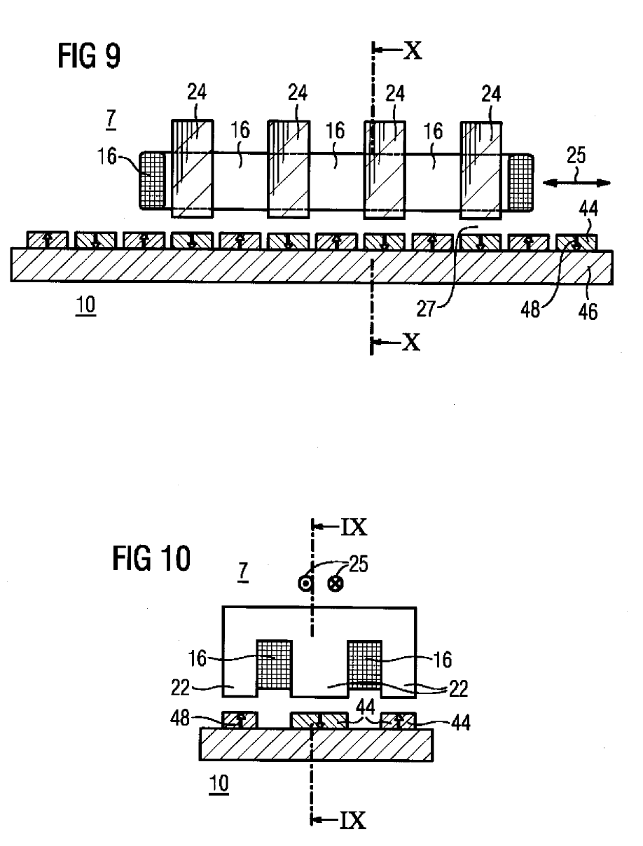

FIG. 9 shows a secondary part with permanent magnets and an associated primary part with laminated individual teeth,

FIG. 10 shows a section through the primary part and the secondary part shown in FIG. 9,

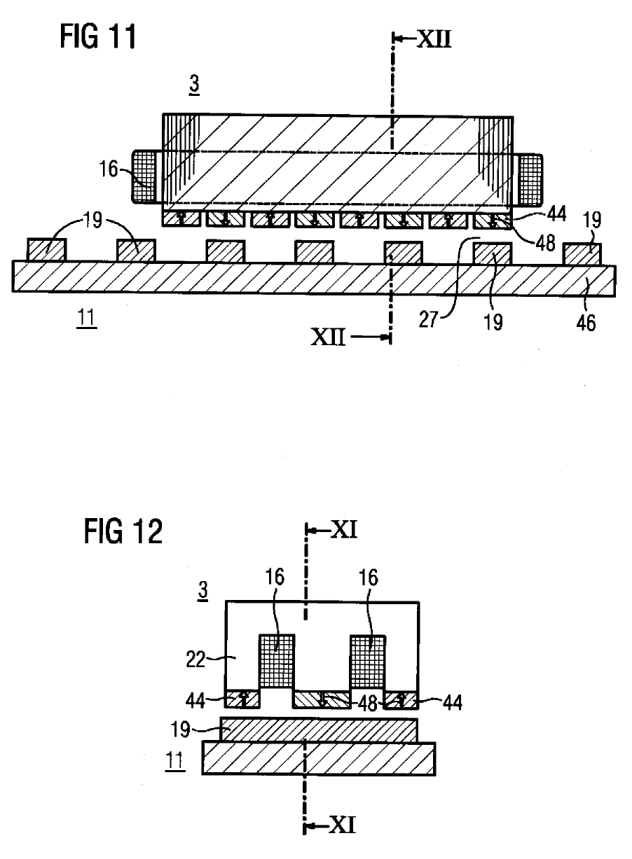

FIG. 11 shows a primary part and a secondary part of the electrical machine, the primary part being free of magnetic sources for forming an excitation field,

FIG. 12 shows a section through the primary part and the secondary part shown in FIG. 11,

FIG. 13 shows an electrical machine which has three air-gap faces arranged in the form of a polygon and three phase windings,

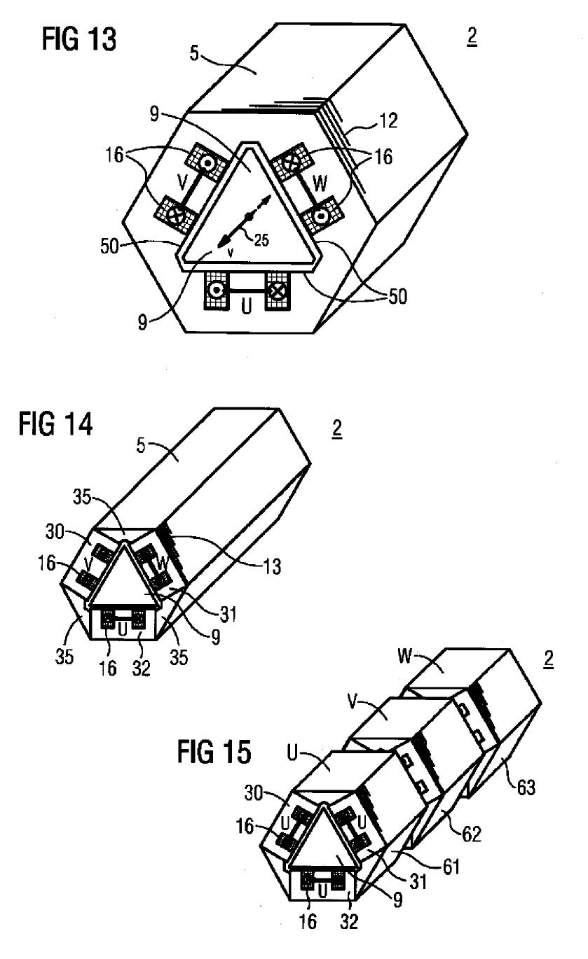

FIG. 14 shows an electrical machine which has three phase windings arranged in the form of a polygon, the laminate stack of the primary part having laminate elements in the laminate section,

FIG. 15 shows an electrical machine which has winding section modules,

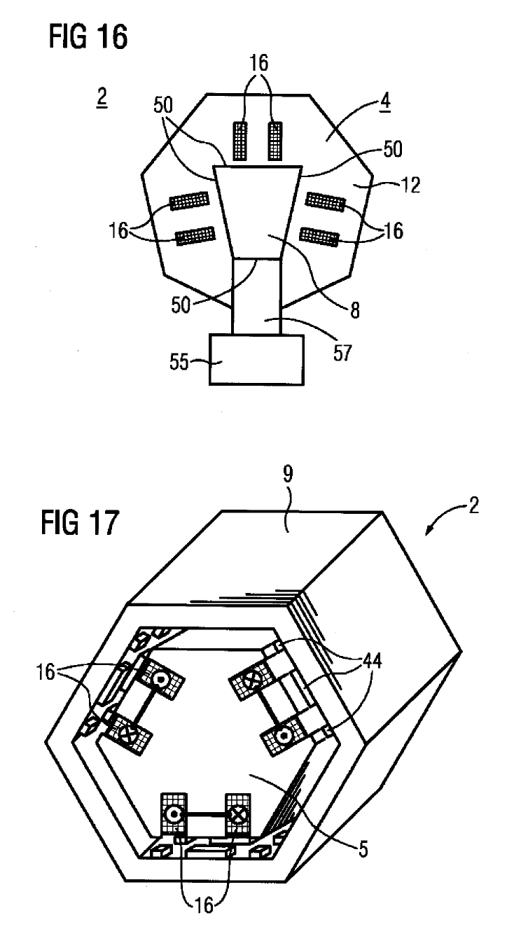

FIG. 16 shows an electrical machine which has an open polygonal arrangement,

FIG. 17 shows an electrical machine in an embodiment as an outer rotor,

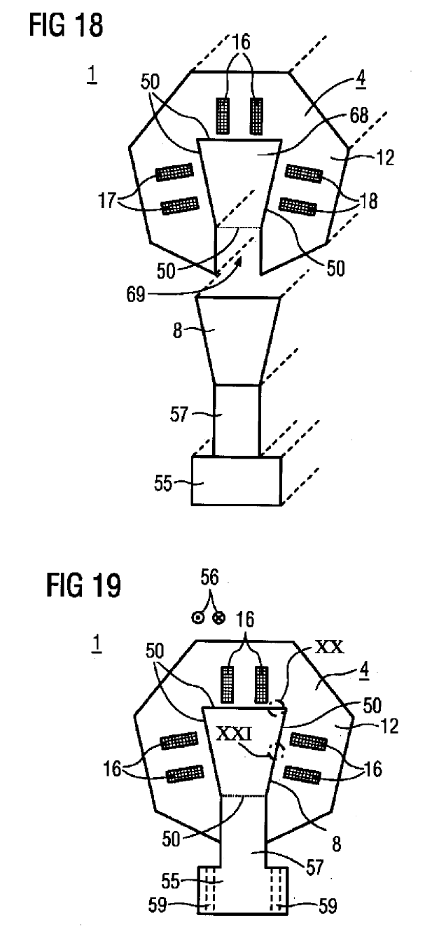

FIG. 18 shows an electrical machine as shown in FIG. 16, the primary part and the secondary part being illustrated separately from one another,

FIG. 19 shows an electrical machine which has an integral secondary part,

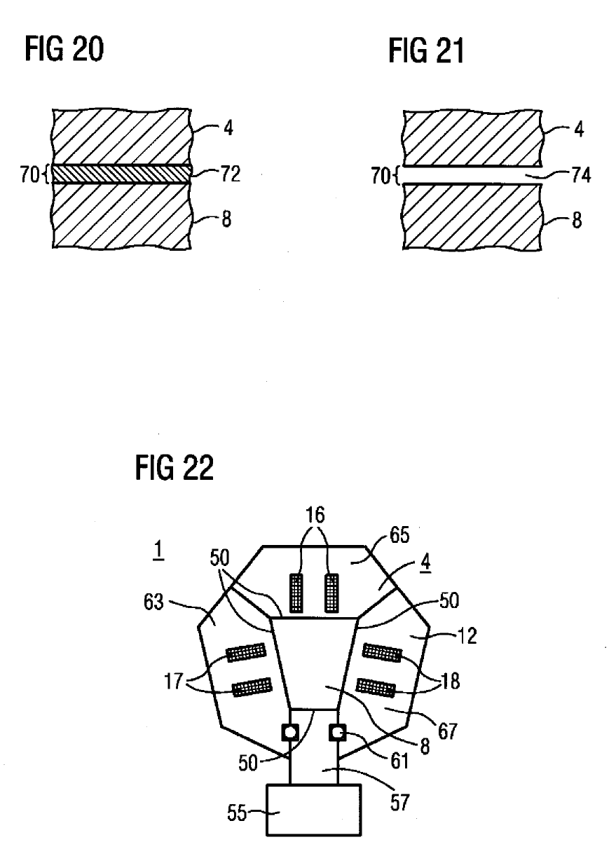

FIG. 20 shows a sliding layer between the primary part and the secondary part of the electrical machine,

FIG. 21 shows an air gap formed by means of air between the primary part and the secondary part of the electrical machine,

FIG. 22 shows an electrical machine which has a recirculating ball device,

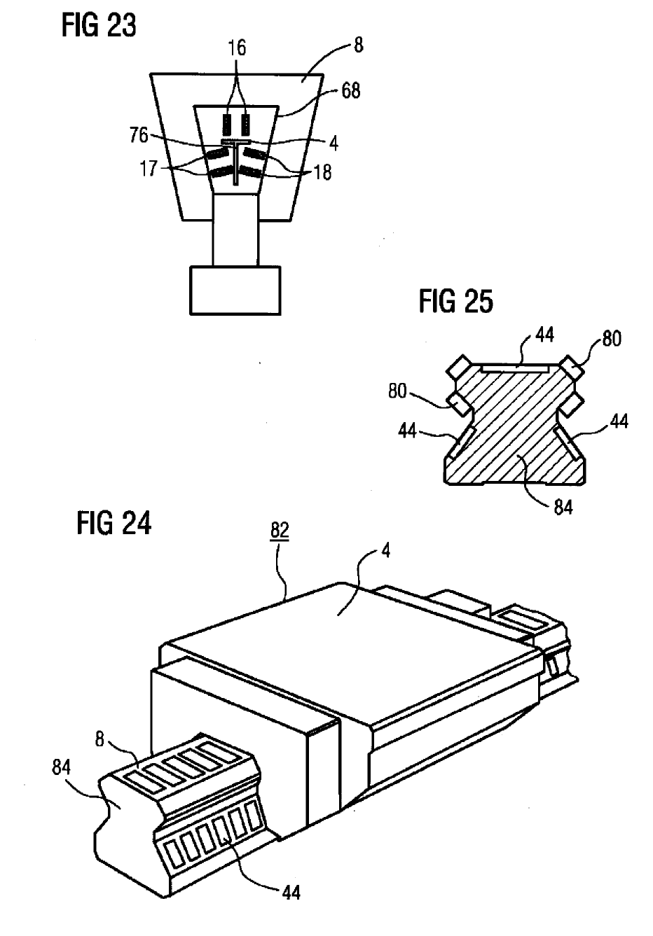

FIG. 23 shows an electrical machine which has a secondary part having a slot-like receptacle,

FIG. 23 shows an electrical machine which has a secondary part which has a slot-like receptacle for a primary part,

FIG. 24 shows a primary part, which is integrated in a recirculating roller device, a secondary part being integrated in a profiled rail, and

FIG. 25 shows the cross section of the profiled rail shown in FIG. 24.

In this case, the illustrations shown in FIGS. 7 to 12, inter alia, also specify basic electromagnetic design forms of a linear motor, which are for different structural design forms, as are illustrated, for example, in FIGS. 16 to 23. In general, different features of electrical machines according to the invention are disclosed in the figures which can also be combined with one another, the wide variety of different combinations not being illustrated.

The illustration shown in FIG. 1 shows an electrical machine 1, which has a primary part 4 and a secondary part 8. An air gap 27, whose air-gap faces 50, 51 are arranged in the form of a polygon, is located between the primary part 4 and the secondary part 8. The air-gap faces 50 and 51 correspond to the sides 50 and 51 of a polygon. The polygon sides of the primary part 4 are denoted by the reference symbol 50, and the polygon sides of the secondary part 8 are denoted by 51. The electrical machine 1 is provided for performing a linear movement and, as a result, is either a linear motor and/or a linear generator. Depending on whether the primary part or the secondary part is positioned in stationary fashion, either the secondary part or the primary part performs a linear movement. In FIG. 1, a linear movement of the secondary part 8 is provided, a double arrow indicating possible linear movement directions 25 of the secondary part 8. The primary part 4 is designed such that it is provided for accommodating windings 16. An end winding 17 is indicated symbolically by a line, the line being arranged between two circles, which have a cross and a dot to indicate a current direction. In FIG. 1, only one winding 16 is shown in order to better illustrate the design of the electrical machine 1. The primary part 4 has a laminate stack 12. The laminate section of the laminate stack 12 is designed in accordance with the front view of the electrical machine 1 shown in FIG. 1 and has laminates lying one behind the other in the movement direction 25. These laminates lying one behind the other are designed to be integral. Through the laminate section, the primary part 4 has slots 20 and 21. The slots 21 have already been fitted with a winding 16, for example. The slots 20 are also intended to be fitted with a winding, this not being illustrated in FIG. 1. The winding 16 in the slots 21 is a phase winding. The slots 21 are intended to be fitted with a further winding (phase winding). The winding in the slots 21 and the winding (not illustrated in FIG. 1) in the slots 20 form coils. Owing to the position of the slots 20 and 21, a polygonal arrangement of the windings results in the primary part 4. The polygon formed has four sides 50. A first side of the polygon is formed by the winding 16 in the slots 21. A second side of the polygon is formed by the winding (not illustrated) in the slots 20. Since the two illustrated slots 20 are now spaced apart from the two illustrated slots 21, a polygon is formed. The polygon has n=4 sides, in the present example the sides having approximately the same length. Advantageously, the secondary part 8 has, in cross section, a shape corresponding to the arrangement of the windings. The secondary part 8 in FIG. 1 has four sides 51, which face the sides 50 of the primary part 4. The four sides 51 of the secondary part 8 form the polygonal cross section of the secondary part 8. The secondary part 8 is illustrated schematically in FIG. 1, with the result that its design is not illustrated in detail. A more detailed illustration of the secondary part is provided in FIGS. 7 to 12. In FIGS. 7 to 12, in addition to various types of secondary parts, associated primary parts are also illustrated. Both the electrical machine shown in FIG. 1 and the electrical machines in FIGS. 2, 3, 5, 13, 14, 15 and 16 (described below) can be configured in accordance with the types in FIGS. 7 to 12. In this case, the use of these types is not restricted to the types of polygon used by way of example in the figures having four polygon sides or having three polygon sides, with the result that polygons with more than four sides are also possible, but are not illustrated.

In an electrical machine 1 shown in FIG. 1, magnetic fields are guided in a plane aligned transversely with respect to the movement direction 25. This results in a quadrature-axis flux magnetic circuit. These magnetic fields guided transversely with respect to the movement direction 25 relate to useful magnetic fields, i.e. in particular the magnetic fields which originate from an excitation and are coupled to the winding of the primary part 4. The excitation field can be produced, for example, by permanent magnets. The permanent magnets are not illustrated in FIG. 1, but possible positioning of the permanent magnets is shown in FIGS. 7 to 12. The secondary part 8 is therefore designed, for example, such that it has permanent magnets or such that it acts as a type of iron reaction rod.

As shown in FIG. 1, individual laminates of the laminate stack 12 are stacked in the movement direction 25 of the electrical machine 1. An active (force-forming) face of the electrical machine 1 is in the form of a polygon with n=4 sides 50, 51.

The illustration in FIG. 2 shows an electrical machine 1, which has a polygon shape with four sides 51, as in FIG. 1, the polygon shape relating both to the secondary part 8 and the primary part 4. In the case of the primary part 4, the polygon shape results owing to the polygonal arrangement of four windings 16. The windings 16 are accommodated in slots 20, the slots 20 being formed by laminate elements 30, 31, 32 and 33. Each laminate element 30, 31, 32 and 33 has one winding 16. Owing to the slots 20, the laminate elements 30, 31, 32 and 33 have the form of the letter E. With the aid of each of the laminate elements 30, 31, 32 and 33, one side of the four-sided polygon is formed. Owing to the use of the laminate elements 30, 31, 32 and 33, filling of the slots 20 can be carried out in a simplified manner since this can take place before the laminate stack is assembled. The laminate elements 30, 31, 32 and 33 adjoin intermediate pieces 35. The laminate stack 13 is constructed in cross section (transversely with respect to the movement direction 25) such that it has a plurality of parts. These parts are the laminate elements 30, 31, 32 and 33 and the intermediate pieces 35, to which the laminate elements are structurally connected.

The illustration shown in FIG. 3 shows an electrical machine 1 which has a similar design to the electrical machine 1 shown in FIG. 2. In contrast to FIG. 2, the electrical machine 1 in FIG. 3 has a laminate stack 12, which is constructed from integral individual laminates. This has the advantage of a simpler design. For reasons of clarity, only one winding 16 is shown. In the laminate section of the primary part 4, a specific corner contour 42 is also shown between the sides of the polygonal opening of the primary part 4, which is provided for the secondary part. For example, linear guides can be integrated in the corner contour 42.

The illustration shown in FIG. 4 shows a laminate section 39 similar to that in FIG. 3. In FIG. 4, the polygon sides 50 of the polygonal opening of the primary part 4, which is provided for the secondary part, are also provided with reference symbols. The laminate section shown in FIG. 4 shows teeth 22 which, for the improved clarity of the preceding FIGS. 1 to 3, are provided with reference symbols for the first time here. The teeth 22 are provided for guiding a useful magnetic flux.

The illustration in FIG. 5 shows an electrical machine 2 which has a primary part 5 and a secondary part 9, both parts having a polygonal structure, which has three polygon sides 50. Flattened portions 53 of the regions in which the polygon sides 50 coincide do not influence the basic three-sided shape polygon. The electrical machine 2 in FIG. 5 differs from the electrical machine 1, which is known, for example, from FIG. 1, essentially by the three-sided polygon shape. The air-gap faces 50, 51 and the associated windings 16 are therefore positioned in the primary part 5 such that they form a polygon with three polygon sides 50 and 51, respectively. The polygon sides 50 and 51 in this case also relate, in addition to the edges of the polygon in a two-dimensional view, to the polygonal arrangement of the associated faces with respect to the extent of the electrical machine in its potential movement direction.

The illustration shown in FIG. 6 shows the laminate section 40 of the laminate stack 12 from FIG. 5.

The illustrations shown in FIGS. 7 to 12 show primary parts 3, 6 and 7 and secondary parts 10 and 11. In these illustrations, always only one polygon side of an electrical machine 1, 2 is shown, which is illustrated by way of example in FIGS. 1, 2, 3, 5, 13, 14, 15 and 16. FIGS. 7 to 12 serve to illustrate the operating principle of the electrical machine.

The illustration shown in FIG. 7 shows a primary part 6 and a secondary part 10, which is spaced apart therefrom by an air gap 27. The secondary part 10 has a mount 46, on which permanent magnets 44 are fitted. The permanent magnets have alternately different magnetization directions 48 and are used for forming an excitation field. The mount 46 advantageously has a soft-magnetic material and may be laminated or solid. The primary part 6 has a winding 16 and a laminate stack 12. The laminate stack 12 has teeth 23 over the movement direction 25. The primary part 6 therefore has a laminate stack structure which is provided with teeth on the air-gap side. A yoke 14 has a continuous laminate stack. The teeth 23 have the same distance from one another as the permanent magnets 44 with the same magnetization direction 48.

FIG. 7 also illustrates the position of the permanent magnets 43 and 45 in the region of a second and third polygon side of the secondary part, for example for a three-phase electrical machine as shown in FIG. 5, 13, 14 or 16. The permanent magnets 43 of the second polygon side are shifted through 120° electrical. The permanent magnets 45 of the third polygon side are shifted through a further 120°.

The illustration in FIG. 8 shows a cross section through the arrangement shown in FIG. 7. In this case, the cross section is passed through a tooth 23. It can be seen from FIG. 8 that the secondary part 10 has permanent magnets 44 with alternately different magnetization directions 48 transversely with respect to the movement direction 25. Further teeth 22 of the primary part 6 are located opposite the permanent magnets 44. FIG. 8 also serves to illustrate the quadrature-axis flux arrangement. Owing to the permanent magnets 44, an excitation flux is built up whose profile is illustrated by magnetic lines of force 70 in the FIG. This profile of the magnetic lines of force 70 runs transversely with respect to the potential movement direction 25. A useful magnetic flux is guided in a plane aligned transversely with respect to a movement direction 25. The useful magnetic flux is the magnetic flux which is coupled or linked to the winding 16. This useful magnetic flux aligned in such a way forms a quadrature-axis flux magnetic circuit. This results in the term quadrature-axis flux arrangement. In FIG. 8, a section is also drawn, this section running through the central tooth 22. This section is illustrated in FIG. 7.

The illustration in FIG. 9 shows an arrangement of the primary part 7 and the secondary part 10 similar to that in FIG. 7. In contrast to FIG. 7, the primary part 7 in FIG. 9 has individual teeth 24, which have the function of the teeth 23 in FIG. 7. The individual teeth 24 are connected to one another, for example, via a nonmagnetic frame (not illustrated). FIG. 9 therefore shows an embodiment without a yoke consisting of soft-magnetic material (laminate stack). The individual teeth 24 are formed, for example, by means of E-shaped laminate stacks. The cross section from FIG. 10 shows the E-shaped design. The individual teeth 24 have the same distance from one another as the permanent magnets 44 with the same magnetization direction 48.

The phase shift required for a three-phase electrical machine, i.e. an electrical machine which is provided for operation with three phases U, V and W, can be realized, for example, by a corresponding shift of the permanent magnets 44, as is indicated in FIG. 7. Another possibility for realizing the shift consists in shifting the tooth structure of various winding sections, i.e. phases, on the primary part. If the tooth structure of winding sections (windings) of different phases is shifted, it is not necessary to shift the permanent magnets of one polygon side of the secondary part in relation to another polygon side of the secondary part.

The illustration in FIG. 10 shows a cross section through the arrangement shown in FIG. 9. In this case, the cross section is drawn through an individual tooth 24. It can also be seen in FIG. 10 that the secondary part 10 has permanent magnets 44 with alternatively different magnetization directions 48 transversely with respect to the movement direction 25. In FIG. 10, a section is also drawn, this section passing through the central tooth 22. This section is illustrated in FIG. 9.

The illustration shown in FIG. 11 shows a primary part 3 and a secondary part 11. The secondary part 11 is free of magnetic sources such as permanent magnets, for example. The secondary part has a mount 46. Bars 19 are located on the mount, which results in a toothed structure on the air-gap side. The bars 19 are laminated transversely with respect to the movement direction 25. The primary part 3 has both a winding 16 and permanent magnets 44 for producing an excitation field. The magnetization directions 48 of the permanent magnets 44 alternate.

The illustration shown in FIG. 12 shows a cross section through the arrangement shown in FIG. 11. In FIG. 12, a section is also drawn, this section passing through the central tooth 22. This section is illustrated in FIG. 11.

The illustration shown in FIG. 13 shows an electrical machine 2. This electrical machine 2 corresponds in terms of its design to the electrical machine 2 shown in FIG. 5. FIG. 13 also shows how current can flow through the windings 16. The windings 16 of in each case one polygon side 50 have current flowing through them with different phases U, V and W of an AC system.

The illustration shown in FIG. 14 shows an electrical machine 2 which has a primary part, this primary part 5 having a laminate stack 13, which comprises various laminate elements 30, 31 and 32. This basically corresponds to the construction described in FIG. 2. The intermediate laminates do not necessarily need to be manufactured from a metal sheet or a soft-magnetic material. The intermediate laminates may also consist of, for example, a plastic or have such a material. The windings 16 are intended to have current applied to them with a phase U, V and W. The polygon is therefore formed by the windings of the phases U, V and W and the corresponding air-gap faces.

The illustration in FIG. 15 shows a further possible design of the electrical machine according to the invention. The electrical machine 2 shown in FIG. 15 has a modular design. In the exemplary embodiment illustrated, the electrical machine 2 has three modules 61, 62 and 63. The modules 60, 61 and 62 correspond in terms of their structural design to the electrical machine 2 in FIG. 14. In contrast to FIG. 14, in FIG. 15 the windings 16 of one module have current applied to them with only one phase U or V or W. The modules 60, 61 and 62 are positioned one behind the other in the movement direction. The positioning takes place such that the modules are arranged one behind the other in shifted fashion. In this case, a shift of 120° electrical is advantageous.

A plurality of embodiments as shown in FIG. 13 or FIG. 14 can also be arranged as modules one behind the other in order to increase the thrust force. In this case, a shift of 120° electrical is not required, since each module is intended to be connected to all three phases U, V and W of an alternating current. This example of a modular design is not illustrated in the FIGS. The shift between the phases U, V and W required for performing a movement is provided in the embodiments shown in FIGS. 13 and 14 by the configuration of the secondary part, as is also described in FIG. 7.

The illustrations shown in FIGS. 13, 14 and 15 show that the windings 16 of the electrical machine advantageously have three winding sections. Each winding section has a winding 16, which is provided for applying current to a phase. In a three-phase AC system, these are the phases U, V and W. The winding sections of the electrical machine can be distributed over the circumference of the polygon and/or in a longitudinal direction (movement direction) of the electrical machine, which is in particular a linear motor. Each winding of a winding section has at least one coil.

The illustration shown in FIG. 16 shows an electrical machine 2 which has a primary part 4 and a secondary part 8. The secondary part 8 is connected to a guide strip 55 via a lug 57. Owing to the lug 57, an open polygon is formed with the windings 16 with respect to the primary part 4. As a result, the electrical machine 2 is designed to correspond to the electrical machines in FIG. 5, 13, 14 or 15 with respect to its electrical design, but has a polygon structure with four polygon sides 50. A type of support area for the electrical machine 2 is provided by the polygon side 50 with the lug 57. This polygon side does not have a magnetically active air gap and therefore does not form any thrust force.

The primary part of a linear motor according to the invention can be built up in modular fashion from a plurality of laminate stacks, with the result that various motors having differing thrust force can be manufactured in a simple manner from a reasonable number of components.

The illustrations shown in FIGS. 1 to 3, 5 and 13 to 16 show electrical machines 1, 2 in which the secondary part 8, 9 is arranged in an inner region of the electrical machine 1, 2, the primary part 4, 5 being arranged in an outer region of the electrical machine 1, 2. In such an arrangement, the secondary part 8, 9 is surrounded at least partially by the primary part 4, 5. The illustration shown in FIG. 17 shows an electrical machine 2 with an arrangement which is inverse to this arrangement. In this inverse arrangement in FIG. 17, the secondary part 9 is positioned in the outer region of the electrical machine, the primary part 5 being arranged in the inner region of the electrical machine. The secondary part 9 therefore at least partially surrounds the primary part 5, which has the windings 16. Two mutually inverse arrangements of the primary part and the secondary part are therefore possible. FIG. 17 also illustrates possible positions for the permanent magnets 44. It can be seen from their position and the position of the windings 16 that this electrical machine 2 in FIG. 17 has three magnetically active polygon sides and three magnetically inactive polygon sides.

The illustration in FIG. 5 shows an electrical machine 2 which has a primary part 5 and a secondary part 9, both parts having a polygonal structure, which has three polygon sides 50. Flattened portions 53 of the regions in which the polygon sides 50 coincide do not influence the basic three-sides polygon shape. The electrical machine 2 in FIG. 5 differs from the electrical machine 1, which is known, for example, from FIG. 1, essentially by the three-sided polygon shape. The air-gap faces 50, 51 and the associated windings 16 are therefore positioned in the primary part 5 such that they form a polygon with three polygon sides 50 and 51, respectively. The polygon sides 50 and 51 in this case also relate, in addition to the edges of the polygon in a two-dimensional view, to the polygonal arrangement of the associated faces with respect to the extent of the electrical machine in its potential movement direction.

The illustration shown in FIG. 18 shows the electrical machine 1 shown in FIG. 16, the primary part 4 and the secondary part 8 being illustrated separately from one another in FIG. 18. The separate illustration shows the polygonal shape both of the primary part 4 and of the secondary part 8. The polygonal shape relates in each case to the cross section in a longitudinal direction, which is illustrated by dash-dotted continuations of the contour in FIG. 18. The illustration further shows that the polygon formed by the polygon sides 50 not only relates to concrete sides of the primary part 4 and the secondary part 8, but also to the imaginary polygon side 50 illustrated by a dotted line. The illustration in FIG. 18 shows a polygon with four polygon sides. It does not illustrate embodiments which have a polygon with fewer than four polygon sides or else with more than four polygon sides. If the number of polygon sides is increased to infinity, it is also possible to design a circular shape, which is not illustrated, however. In addition, FIG. 18 shows a slot-like receptacle 68 and an opening 69. The primary part has three windings 16, 17 and 18. Each winding 16, 17 and 18 is associated with one polygon side of the primary part 4. A primary part can also be designed such that it has, for example, only one winding 16 on one polygon side 50. This variant is not illustrated in FIG. 18, however.

The illustration shown in FIG. 19 shows, similarly to FIG. 16, an electrical machine 1 in cross section, i.e. transversely with respect to a movement direction 56. Different opposite movement directions 56 are indicated by a dot or by a cross in a circle. A movement is provided along the guide strip 55. In the electrical machine 1 in FIG. 19, in contrast to that in FIG. 16, the secondary part 8, the lug 57 and the guide strip 55 are designed to be integral. The guide strip 55 has fixing holes 59. Screws, for example, can be inserted into said fixing holes 59 and are used for fixing the entire electrical machine 1, for example to a machine tool. The lug 57 is used as a support area for the secondary part 8 and therefore as the support area for the electrical machine 1. In the illustration shown in FIG. 19, reference is also made to FIGS. 20 and 21. These FIGS. relate to the illustration of distances between the primary part 4 and the secondary part 8, which are not illustrated in detail, for example, in FIGS. 16 and 19. The distances between the primary part and the secondary part 8 form an air gap. The air gap is filled either with air or else with a material which has similar electrical and/or magnetic properties to air.

The illustration shown in FIG. 20 shows a first type of air gap 70 between the primary part 4 and the secondary part 8, which has a sliding layer 72. A contact region is formed between the primary part 4 and the secondary part 8 via the sliding layer 72. The sliding layer 72 has a slide-promoting surface, the sliding layer 72 either adhering to the primary part 4 and/or to the secondary part 8.

The illustration shown in FIG. 21 shows a second type of air gap 70 between the primary part 4 and the secondary part 8, which has air 74 for forming the air gap 70.

An electrical machine can have, as the air gap, only one type of air gap as shown in FIGS. 20 and 21 or else may have both types of air gaps.

The illustration shown in FIG. 22 shows, in cross section, a ball-type roller bearing 61 integrated in the electrical machine 1. In addition, this illustration shows a laminate stack 12, which is split into three laminate stack elements 63, 65 and 67. The laminate stack elements adjoin one another and therefore form a common laminate stack. Each laminate stack element has a dedicated winding 16, 17 and 18. This is used in particular for simpler manufacture, since the windings 16, 17 and 18 can be introduced separately from one another into the laminate stack elements 63, 65 and 67 and only then is the polygonal shape formed by the arrangement of the laminate stack elements 63, 65 and 67.

The illustration shown in FIG. 23 shows an electrical machine 1, in which the slot-like receptacle 68 is formed by the secondary part 8, the primary part 4 being accommodated in the slot-like receptacle. Since the primary part 4 shown in FIG. 23 has a compact design, it has cutouts 76 for the purpose of magnetically delimiting the windings 16, 17 and 18. These cutouts 76 are, for example, stamped-out portions from the laminate stack, which has the primary part 4. The cutouts 76 are advantageously filled with air.

The illustration shown in FIG. 24 shows an electrical machine 1, which shows a primary part 4 integrated in a recirculating roller device 82. The recirculating roller device 82 is placed on a profiled rail 84. The profiled rail 84 has permanent magnets 44. The profiled rail 84 is therefore formed as the secondary part 8 of the electrical machine 1.

The illustration shown in FIG. 25 shows a cross section of the profiled rail 84, rollers 80, which run in the recirculating roller device 84 known from FIG. 24, being illustrated in addition to the representation of the design.

1.-23. (canceled)

24. An electrical machine for performing a linear movement, comprising:
a primary part having windings for producing a magnetic field; and
a secondary part having a guiding means for guiding a magnetic flux,
wherein an air-gap face is formed between the primary part and the secondary part, and
wherein at least one member selected from the group consisting of the windings and the air-gap faces is arranged in the form of a polygon.

25. The electrical machine of claim 24, constructed as a linear motor.

26. The electrical machine of claim 24, wherein the primary part has a laminate stack which is laminated transversely in relation to a movement direction of the electrical machine, with a useful magnetic flux being producible transversely to the movement direction of the electrical machine.

27. The electrical machine of claim 24, wherein the secondary part has a polygonal cross section in correspondence to the polygonal arrangement of the windings of the primary part.

28. The electrical machine of claim 24, wherein the secondary part is surrounded at least partially by the primary part.

29. The electrical machine of claim 24, wherein the primary part comprises a plurality of laminate stacks, each of which forming one side of the polygon.

30. The electrical machine of claim 25, wherein the primary part or the secondary part has permanent magnets arranged to form a phase shift for a uniform formation of force by shifting permanent magnets associated with one phase or one phase winding section in relation to permanent magnets of a further phase or a further phase winding section along the movement direction.

31. The electrical machine of claim 30, wherein the shift corresponds to 120 electrical degrees.

32. The electrical machine of claim 30, constructed for operation with a three-phase alternating current.

33. The electrical machine of claim 25, wherein the primary part or the secondary part has teeth arranged to form a phase shift for a uniform formation of force by shifting teeth associated with one phase or one phase winding section in relation to teeth of a further phase or a further phase winding section along the movement direction.

34. The electrical machine of claim 33, wherein the shift corresponds to 120 electrical degrees.

35. The electrical machine of claim 33, constructed for operation with a three-phase alternating current.

36. The electrical machine of claim 24, wherein the primary part is arranged in an outer region of the electrical machine, and the secondary part is arranged in an inner region of the electrical machine.

37. The electrical machine of claim 24, wherein the primary part is arranged in an inner region of the electrical machine, and the secondary part is arranged in an outer region of the electrical machine.

38. The electrical machine of claim 24, wherein the primary part has a slot-like receptacle for accommodating at least part of the secondary part.

39. The electrical machine of claim 24, wherein the secondary part has a slot-like receptacle for accommodating at least part of the primary part.

40. A primary part of an electrical machine, comprising windings for producing a magnetic field, wherein the windings are arranged in the form of a polygon.

41. The primary part of claim 40 having a laminate stack which is laminated transversely in relation to a movement direction of the electrical machine, with a useful magnetic flux being producible transversely to the movement direction of the electrical machine.

42. The primary part of claim 40 including a plurality of laminate stacks, each of which forming one side of a polygon.

43. A primary part of an electrical machine, said primary part having windings for producing a magnetic field, and a slot-like receptacle for accommodating at least part of a secondary part which is a component of the electrical machine and has a means for guiding a magnetic flux.

44. The primary part of claim 43, wherein the slot-like receptacle is constructed to act as a guide for guiding the primary part in relation to the secondary part.

45. The primary part of claim 43, constructed for integration in a recirculating roller unit and/or a recirculating ball unit of a linear guide.

46. The primary part of claim 43, having a contact region with the secondary part, said contact region being located in a region of the slot-like receptacle, said primary part having a slide-promoting surface in the contact region.

47. A secondary part of an electrical machine, comprising a means for guiding a magnetic flux, and a slot-like receptacle for accommodating at least part of a primary part which is a component of the electrical machine and has windings for producing a magnetic field.

48. The secondary part of claim 47, wherein the slot-like receptacle is constructed to act as a guide for guiding the primary part in relation to the secondary part.

49. The secondary part of claim 47, constructed for integration in a recirculating roller unit and/or a recirculating ball unit of a linear guide.

50. The secondary part of claim 47, having a contact region with the primary part, said contact region being located in a region of the slot-like receptacle, said secondary part having a slide-promoting surface in the contact region.

51. An electrical machine, comprising:
a primary part;
a secondary part; and
a guide which is at least partially integrated in at least one member selected from the group consisting of the primary part and the secondary part.

52. The electrical machine of claim 51, wherein the secondary part is used as a support area for the primary part.

53. An electrical machine, comprising:
a primary part; and
a secondary part,
wherein the primary part is constructed to only partially surround at least part of the secondary part, or the secondary part is constructed to only partially surround at least part of the primary part.

54. The electrical machine of claim 53, further comprising a guide integrated at least partially in at least one member selected from the group consisting of the primary part and the secondary part.

55. The electrical machine of claim 53, wherein the secondary part is used as a support area for the primary part.
